(19) United States
(12) Patent Application Publication
(10) Pub. No.: US 2012/0167516 A1
(43) Pub. Date: Jul. 5, 2012

(54) METHOD OF FORMING PROTRUSIONS ON A MASONRY BLOCK

(76) Inventor: John Kenneth Dyson, Victoria (AU)

(21) Appl. No.: 13/334,489

(22) Filed: Dec. 22, 2011

(30) Foreign Application Priority Data
Dec. 23, 2010 (AU) 2010257396

(51) Int. Cl. E04C 1/00; E04B 1/38; B28B 3/00; B41B 11/52

(52) U.S. Cl. 52/578; 249/160; 52/603; 264/333

(57) ABSTRACT

A method and mould for forming upwardly extending protrusions on a wall masonry block during moulding of the block. The method including pouring a flowable concrete mixture into a lower mould to form a body of said wall masonry block, applying a head shoe to form an upper section of said wall masonry block, the head shoe including a first mould portion for forming an upper bedding face of said block and a second mould portion for forming at least one protrusion extending upwardly from the upper bedding face, the head shoe being shaped to improve the flow of said concrete mixture into the second mould portion during compression of the block, and removing the masonry block from the mould.

### FIELD OF THE INVENTION

The present invention relates generally to the field of masonry blocks and in one aspect relates to a method of forming protrusions extending upwardly from an upper bedding face of a masonry block.

### BACKGROUND OF THE INVENTION

There are several types of masonry blocks used in construction including large hollow precast concrete blocks. The blocks can be used for load-bearing walls of buildings and for constructing of retaining walls. The hollow blocks are reinforced with core filled concrete columns and steel reinforcement bars.

The blocks have one or more vertical apertures extending therethrough, and are either cast smooth sides or they may be split-faced blocks that include a rough, stone-like textured surface on at least one face of the block. The vertical apertures through the blocks interconnect with the apertures of course of blocks above and below the block and permit rebar and core fill concrete to run vertically and horizontally through the wall to compensate for the lack of tensile strength of the wall.

Some masonry blocks are stacked and held together with concrete mortar to form the desired length and height of the wall. The cores or apertures of the blocks however need to be cleaned of excess mortar prior to filling with the core fill concrete.

More recently interlocking concrete block systems have also been developed. The blocks included masonry protrusions that extend upwardly from the upper bedding and are configured to engage with the underside of an overlying block or blocks to retain the blocks in an interlocking relationship during core filling with the concrete. The protrusions are formed during the moulding process of the blocks. The protrusions may be referred to within the industry as nibs or lugs, and it should be understood that these terms might be substitute throughout the specification.

The masonry blocks are formed by pouring a concrete mixture into a lower mould. The lower mould typically comprises an outer mould box containing several mould liners. The liners determine the outer shape of the block and the inner block cavities. When the moulds are full, the concrete is compacted by the weight of the upper mould head or head shoe that is pressed down onto the mould liners. Compaction may be supplemented by air or hydraulic pressure cylinders acting on the mould head. A short burst of mechanical vibration may also be used to further aid compaction. The compacted blocks are then pushed down and out of the moulds onto a pallet that is placed in a curing kiln. The compressive strength of core fill masonry blocks is typically around 15 MPa.

The concrete mixture used for blocks has a higher percentage of sand and a lower percentage of gravel and water than concrete mixtures used for general construction purposes. This produces a dry, stiff mixture that maintains its shape when removed from the block mould. However it also means that the blocks are brittle and the protrusions are often damaged or completely broken off during transport. Typically there is a survival rate of around 50% for the protrusions. The survival rate is calculated as the percentage of protrusions surviving intact at the time of delivery of the blocks onsite.

This damage to the protrusions means that the courses of blocks may no longer be interlocked which can result in blocks becoming dislodged during laying, reinforcement and core filling with the concrete. The resultant blow out of the wall can be a costly and time-consuming problem to rectify.

It should be appreciated that any discussion of the prior art throughout the specification is included solely for the purpose of providing a context for the present invention and should in no way be considered as an admission that such prior art was widely known or formed part of the common general knowledge in the field as it existed before the priority date of the application.

### SUMMARY OF THE INVENTION

In accordance with an aspect of the invention, but not necessarily the broadest or only aspect, there is proposed a method of forming upwardly extending protrusions on a wall masonry block during moulding including the steps of:

pouring a flowable concrete mixture into a lower mould to form a body of said wall masonry block;

applying a head shoe to form an upper section of said wall masonry block, the head shoe including a first mould portion for forming an upper bedding face of said block and a second mould portion for forming at least one protrusion extending upwardly from the upper bedding face, the head shoe being shaped to improve the flow of said concrete mixture into the second mould portion during compression of the block; and

removing the masonry block from the mould, wherein upon curing the protrusions have a similar hardness to the body of said block for the purpose of improving the shear strength of said protrusions.

The above method including the step of forming at least one indentation in the upper section of the wall masonry block between the bedding face and at least one protrusion thereby urging the flowable concrete mixture into the second mould portion. The shape of the head shoe urges the concrete into the second mould portion thereby compressing the material and increasing the hardness of the protrusions once cured.

The above method, wherein the head show includes a depending portion adjacent the second mould portion and more preferably between the first mould portion and the second mould portion for forming the at least one indentation.

The hardened masonry protrusions extend upwardly from the top of the masonry block for engagement with an overlying masonry block during construction of a wall. In this way an overlying second course of interlocking masonry blocks engage with the hardened protrusions or lugs that extend upwardly from the upper bedding face of the underlying blocks to ensure wall stability during the laying of the blocks, placement of reinforcement rods and core filling with flowable concrete, without the protrusions being damaged during transport.

The core fill blocks have a compressive strength of around 15 MPa and therefore the protrusions preferably have a compressive strength between 10-18 MPa and more preferably between 12-15 MPa.

The increased hardness of the protrusions results in a higher survival rate of the protrusion at the time of delivery of the masonry block to a building or construction site where a wall using the blocks is being built. The survival rate may be at least 60%, or at least 70% or at least 80% or at least 90%.

The masonry block produced using the above method wherein the relative compressive strength between the protrusions and the body of said block is less than 5%, 10%, 20% or 30%.

In one form the masonry block produced using the above method includes a front wall and a rear wall connected by at least one web member. The block may be used in the construction of walls for buildings, including freestanding, and load bearing walls, wherein the front and rear walls have generally the same thickness. Alternatively, the blocks may be used in the construction of retaining walls, wherein the front wall has a greater thickness than the rear wall, the front wall being either moulded or split faced.

The front and rear walls includes respectively a front face and rear face and both including an upper bedding face, a lower bedding face, and at least one generally vertical side adjoining thereto.

The aperture that extends vertical through said block is configured to receive a flowable concrete mixture used in core filling. In one form the blocks being registerable along opposing sides with abutting blocks to inhibit movement of said flowable concrete out through a respective vertical interfaces between said blocks.

In another form the block produced using the above method is an interlocking corner block including a rear face generally parallel a front face, a first end having an end face generally perpendicular and extending between an end of said rear and front faces, an aperture extending vertically through said block for receiving a flowable concrete mixture used in core filling, and

a generally vertical second end, opposite said end face, being registerable with an opposing vertical side of a first abutting block, wherein the rear face including spaced apart engagement members extending down said rear face and registerable with a vertical side of a second abutting block having complementary shaped engagement members to inhibit movement of said flowable concrete out through a vertical interface between said corner block and said second abutting block.

In another aspect of the invention there is proposed a mould for use in forming a wall masonry block including;

a lower mould for receiving a flowable concrete mixture for forming a body of said wall masonry block; and

a head shoe, engagable with said lower mould, for compression of said concrete mixture to form said wall masonry block, the head shoe including a first mould portion for forming an upper bedding face of said block and a second mould portion for forming at least one protrusion extending upwardly from the upper bedding face, wherein the head shoe being shaped to improve the flow of said concrete mixture into the second mould portion during compression of the block.

The masonry block formed using the above mould, wherein upon curing of the block the protrusions have a similar hardness to the body of said block for the purpose of improving the shear strength of said protrusions.

The mould may include a depending portion adjacent the second mould portion, and preferably between the first mould portion and the second mould portion, for compelling the flowable concrete mixture thereinto. This depending portion produces an indentation in the top of the masonry block when formed.

The depending portion of the head shoe means the flowable concrete mixture that forms the protrusions is compressed to increase the hardness of the cured protrusions that results in increased sheer strength. The protrusions are therefore less likely to be damaged or completely broken off during transport and installation, which means the rigidity of the wall is maintained during core filling of the wall.

### BRIEF DESCRIPTION OF THE DRAWINGS

The accompanying drawings, which are incorporated in and constitute a part of this specification, illustrate implementations of the invention and, together with the description and claims, serve to explain the advantages and principles of the invention. In the drawings:

FIG. 1 is an underside perspective view of the head shoe of the present invention, indicating in broken lines the position of the lower mould;

FIG. 2 is a perspective view of a masonry block produced using the head shoe of FIG. 1;

FIG. 3 is a side view of the masonry block of FIG. 2, illustrating the compressed protrusions;

FIG. 4 is an end view of the masonry block of FIG. 2;

FIG. 5 is a top view of a H-block produced using the head shoe of the present invention; and

FIG. 6 is a cross-sectional view of the H-block of FIG. 5 through A-A illustrating the compressed protrusions.

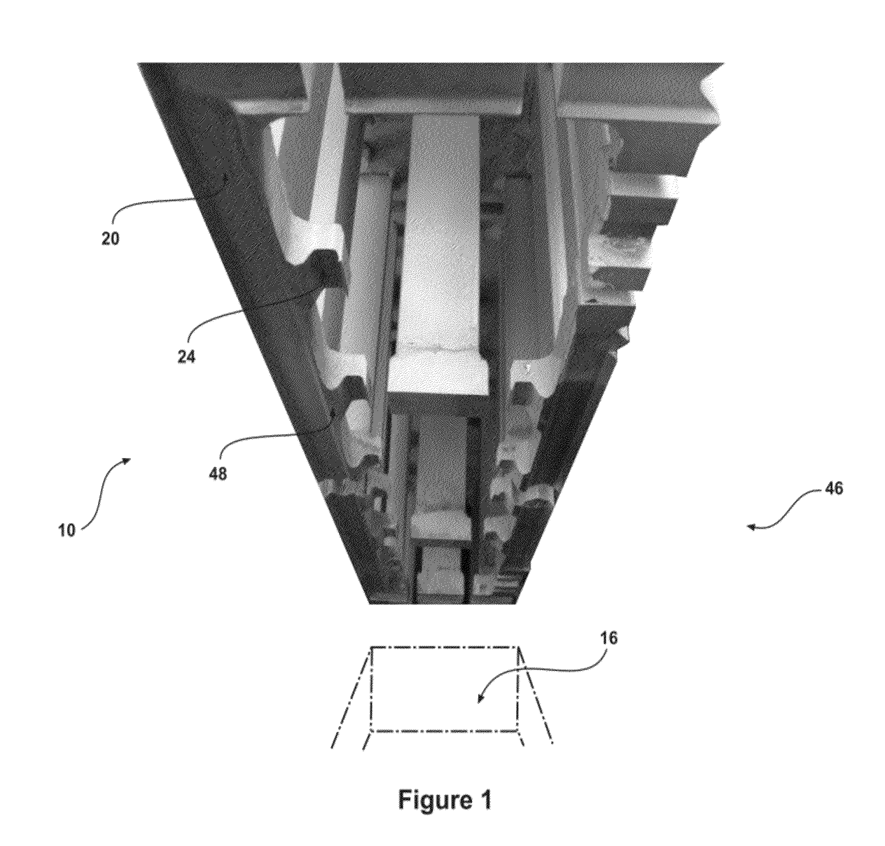

### DETAILED DESCRIPTION OF THE ILLUSTRATED AND EXEMPLIFIED EMBODIMENTS

There are numerous specific details set forth in the following description. However, from the disclosure, it will be apparent to those skilled in the art that modifications and/or substitutions may be made without departing from the scope and spirit of the invention. In some circumstance specific details may have been omitted so as not to obscure the invention. Similar reference characters indicate corresponding parts throughout the drawings.

Referring to the drawings for a more detailed description, a method of using a head shoe 10 to form protrusions 12 on a masonry block 14 is illustrated, demonstrating by way of example an arrangement in which the principles of the present invention may be employed.

The method of forming upwardly extending protrusions 12 on a wall masonry block 14 during moulding includes the steps of:

pouring a flowable concrete mixture into a lower mould 16 to form a body 18 of the wall masonry block 14;

applying the head shoe 10 to form the upper section of said wall masonry block 14, the head shoe 10 including a first mould portion 20 for forming an upper bedding face 22 of said block 14 and a second mould portion 24 for forming the protrusions 12 extending upwardly from the upper bedding face 22, the head shoe 10 being shaped to improve the flow of said concrete mixture into the second mould portion 24 during compression of the block 14; and

removing the masonry block 14 from the mould 16, wherein upon curing the protrusions 12 have a similar hardness to the body 18 of said block 14 for the purpose of improving the shear strength of said protrusions 12.

The masonry protrusions 12 extend upwardly from the top of the masonry block 14 for engagement with an overlying masonry block (not shown) during construction of a wall, as is known in the art. In this way an overlying second course of interlocking masonry blocks engage with the protrusions or lugs that extend upwardly from the upper bedding face of the underlying blocks to ensure wall stability during the laying of the blocks, placement of reinforcement rods and core filling with flowable concrete.

The masonry block 14 produced using the above method includes a front wall and a rear wall connected by at least one web member. The block may be used in the construction of walls for building including freestanding, load bearing walls, wherein the front and rear walls have generally the same thickness. Alternatively the blocks may be used in the construction of retaining walls, wherein the front wall has a greater thickness than the rear wall, the front wall being either moulded or split faced.

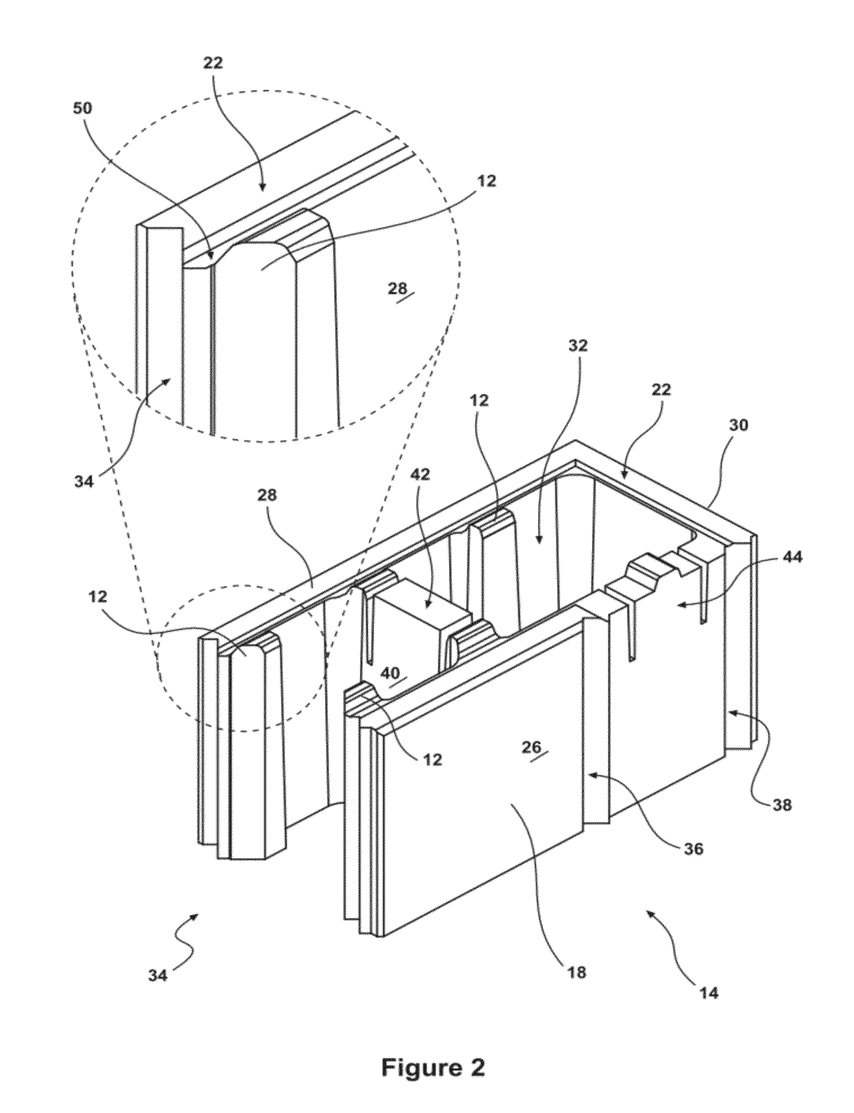

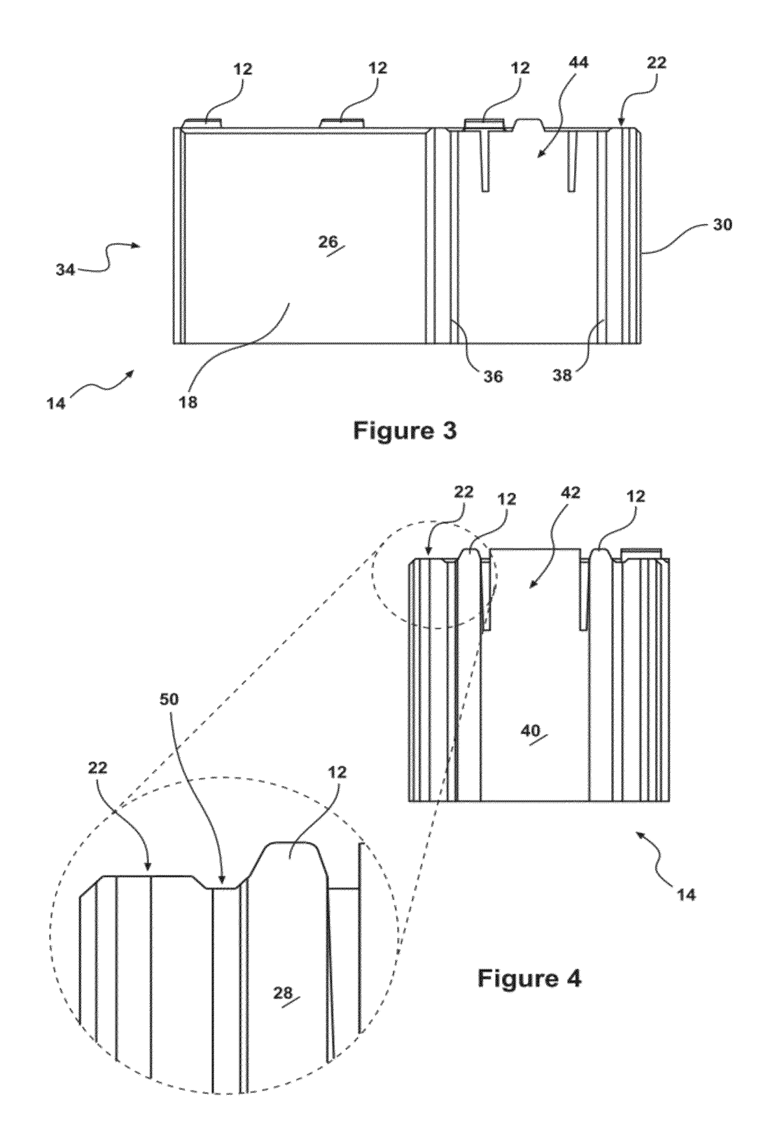

In one embodiment, as illustrated in FIGS. 2 to 4 the block 14 produced using the above method is an interlocking corner block including a rear wall 26 generally parallel a front wall 28, a first end 30 generally perpendicular and extending between an end of said rear and front walls 26, 28, an aperture 32 extending vertically through said block 14 for receiving a flowable concrete mixture used in core filling, and a generally vertical second end 34, opposite said end wall 30, being registerable with an opposing vertical side of a first abutting block (not shown).

The rear wall 26 including spaced apart engagement members 36, 38 extending down an outer face of the rear wall 26 and registerable with a vertical side of a second abutting block (not shown) having complementary shaped engagement members to inhibit movement of said flowable concrete out through a vertical interface between said corner block and said second abutting block.

The block 14 illustrated in the figures further includes a bridge member 40 having a removable upper portion 42. The rear wall 26 may also include a removable portion 44. It should however be appreciated by the reader that the head shoe 10 of the present invention could be used in conjunction with any lower mould to construct blocks of various configuration and sizes having strengthened nibs or projections.

The aperture that extends vertical through the block is configured to receive a flowable concrete mixture used in core filling. In one form the blocks being registerable along opposing sides abutting blocks to inhibit movement of said flowable concrete out through a respective vertical interfaces between said blocks or as illustrated in the figure the block is registerable along one side and the outer face of the rear wall 26.

In another aspect of the invention there is proposed a block mould 46 for use in forming a wall masonry block 14 including, a lower mould 16 for receiving a flowable concrete mixture for forming a body 18 of the wall masonry block 14, a head shoe 10 engagable with the lower mould 16 to compress said concrete mixture for forming an upper section of the wall masonry block 14. The head shoe 10 including a first mould portion 20 for forming an upper bedding face 22 of the block 14, a second mould portion 24 for forming protrusions 12 extending upwardly from the upper bedding face 22, and a depending portion 48 adjacent the second mould portion 24 for compelling the flowable concrete mixture thereinto. The depending portion 48 produces an indentation 50 in the top of the masonry block 14 when formed. The head shoe 10 being shaped to improve the flow of the concrete mixture into the second mould portion during compression of the block.

During production of the blocks 14 sand, gravel, and cement are blended in a stationary mixer for several minutes. Water, admixture chemicals and colouring pigments are then added and the mixture is blended until thoroughly mixed. The concrete mixture is then forced downward into the lower mould 16. The moulds may consist of an outer mould box containing several mould liners (not shown). The liners determine the outer shape of the block and the inner shape of the block cavities.

When the lower moulds 16 are full, the concrete is compacted by the weight of the upper mould head or head shoe 10 that is pressed down on the mould cavities. The compaction may be supplemented by air or hydraulic pressure cylinders acting on the mould head. A short burst of mechanical vibration is also used to further aid compaction. Due to the depending portion 48 of the shoe head 10 the concrete is impelled into the second mould portion 24. The compacted blocks are then pushed down out of the moulds and placed onto a pallet for curing.

As the reader will now appreciate the masonry block 14 formed using the above mould 10, wherein upon curing of the block 14 the protrusions 12 have a similar hardness to the body of the block for the purpose of improving the shear strength of the protrusions 12.

The depending portion 48 of the head shoe 10 means the flowable concrete mixture that forms the protrusions 12 is compressed to increase the hardness of the cured protrusions 12 that results in increased sheer strength. The protrusions are therefore less likely to be damaged or completely broken off during transport and installation, which means the rigidity of the wall is maintained during core filling of the wall.

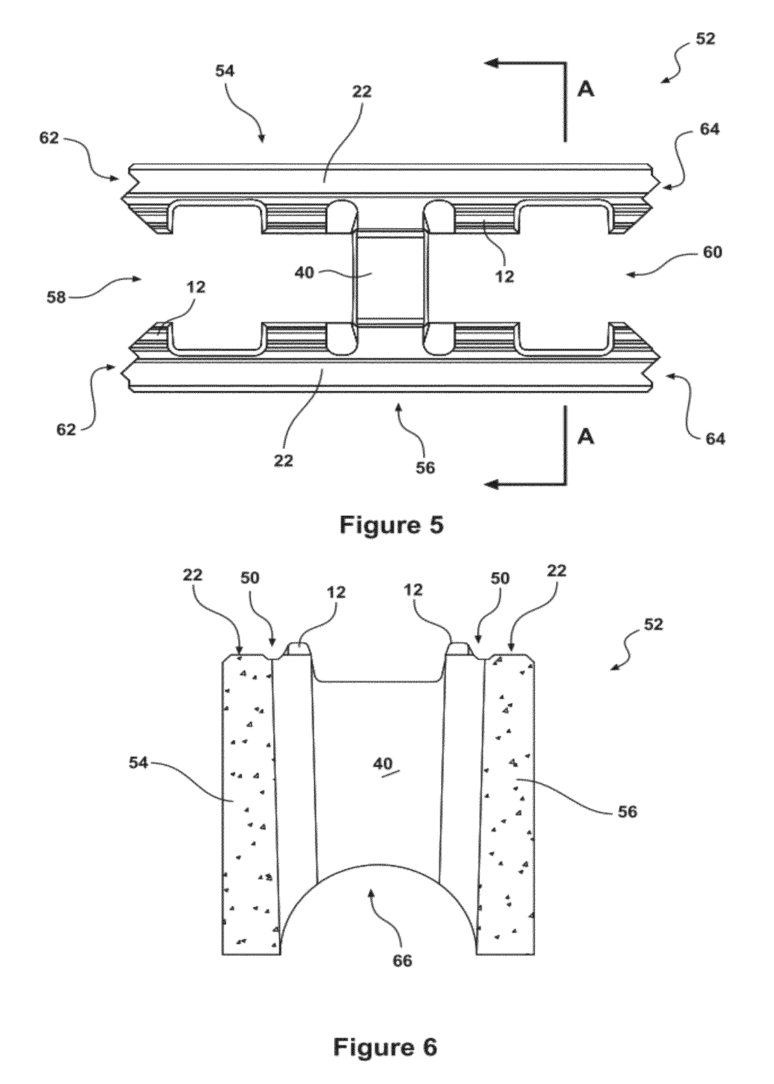

FIGS. 5 and 6 illustrate another embodiment of a H-shaped masonry block 52, produced using the head shoe 10 of the present invention. The illustrated interlocking masonry H-block 52 includes a first wall 54 and second wall 56 connected by a single web member 40. Two sidewardly open apertures 58, 60 extend vertically through the H-block 52 between the walls 54, 56 for receiving a flowable concrete mixture therethrough that is used in the core filling process.

The vertical sides 62, 64 of the first wall 54 and the vertical sides 62, 64 of the second wall 56 are registerable with opposing sides of abutting blocks as is known in the art. It should be appreciated by the reader that the illustrated embodiments of the blocks 14, 52 could be interconnected depending upon the specific configuration or requirements of the wall being constructed. Furthermore, other shaped masonry blocks could be produced using the head shoe 10 of the present invention.

The walls 54, 56 include respective bedding faces 22 and adjacent upwardly extending protrusions 12, as illustrated in FIG. 6.

As further illustrated in FIG. 6, a portion of the web member 40 may be removed after the H-block 52 has been moulded to form an upwardly curved underside 66 of the web member 32. Alternatively the lower mould 16 may be configured to produce a curved underside 66. The removal of this portion of the web member 40 provides a passageway for the movement of flowable concrete during core filling of the wall. The removed portion furthermore provides space for the positioning of the steel reinforcement tie bars and the reduction in the weight of the H-block assists in handling during construction of a wall.

The portion of the web member 32 may be removed during production of the H-block 10 when it is removed from a mould using a core puller. The underside of the web member may be arcuate when the portion is removed or it may be angular or multiple portions may be removed. The portion or portions may be removed from the lower section of the web member or the upper portion or both and may be removed after the block has been cured or at least partially cured.

The skilled addressee will now appreciate the many advantages of the illustrated invention. Increasing the hardness of the nibs or protrusions that extend upwardly from the upper bedding face means that they are less sheer off during transport and installation that results in the wall having greater structural integrity prior to core filling. This reduces the likelihood of a blow out during construction of the wall.

Various features of the invention have been particularly shown and described in connection with the exemplified embodiments of the invention, however, it must be understood that these particular arrangements merely illustrate and that the invention is not limited thereto. Accordingly the invention can include various modifications, which fall within the spirit and scope of the invention. It should be further understood that for the purpose of the specification the word “comprise” or “comprising” means “including but not limited to”.

1. A method of forming upwardly extending protrusions on a wall masonry block during moulding including the steps of:
pouring a flowable concrete mixture into a lower mould to form a body of said wall masonry block;
applying a head shoe to form an upper section of said wall masonry block, the head shoe including a first mould portion for forming an upper bedding face of said block and a second mould portion for forming at least one protrusion extending upwardly from the upper bedding face, the head shoe being shaped to improve the flow of said concrete mixture into the second mould portion during compression of the block; and
removing the masonry block from the mould, wherein upon curing the protrusions have a similar hardness to the body of said block for the purpose of improving the shear strength of said protrusions.

2. The method in accordance with claim 1 further including the step of forming at least one indentation in the upper section of the wall masonry block between the bedding face and at least one protrusion thereby urging the flowable concrete mixture into the second mould portion.

3. The method in accordance with claim 2 wherein the head show includes a depending portion adjacent the second mould portion, for forming said at least one indentation.

4. The method in accordance with claim 3 wherein the depending portion is located between the first mould portion and the second mould portion.

5. The method in accordance with claim 1 wherein the masonry protrusions extend upwardly from the top of the masonry block for engagement with an overlying masonry block during construction of a wall, in this way an overlying second course of interlocking masonry blocks engage with the protrusions that extend upwardly from the upper bedding face of the underlying blocks to provide wall stability.

6. A masonry block produced using the method of claim 1 includes a front wall and a rear wall connected by at least one web member.

7. A masonry block produced using the method of claim 1 wherein the compressive strength of the protrusions is between 10-18 MPa.

8. A masonry block produced using the method of claim 1 wherein the compressive strength of the protrusions is between 12-15 MPa.

9. A masonry block produced using the method of claim 1 wherein the compressive strength of the protrusions is between 14-15 MPa.

10. A masonry block produced using the method of claim 1 wherein the compressive strength of the protrusions is greater than 9, 10, 11, 12, 13, 14, 15, 16, 17, 18, or 19 MPa.

11. A masonry block produced using the method of claim 1 wherein the survival rate of the protrusion at the time of delivery of said masonry block onsite is at least 60%, 70%, 80% or 90%.

12. A masonry block produced using the method of claim 1 wherein the relative compressive strength between the protrusions and the body of said block is less than 5%, 10%, 20% or 30%.

13. A masonry block produced using the method of claim 1 wherein the masonry block interlocks with a horizontally adjacent block.

14. A mould for use in forming a wall masonry block including;
a lower mould for receiving a flowable concrete mixture for forming a body of said wall masonry block; and
a head shoe, engagable with said lower mould, for compression of said concrete mixture to form said wall masonry block, the head shoe including a first mould portion for forming an upper bedding face of said block and a second mould portion for forming at least one protrusion extending upwardly from the upper bedding face, wherein the head shoe being shaped to improve the flow of said concrete mixture into the second mould portion during compression of the block.

15. A masonry block formed using the mould of claim 14, wherein upon curing of the block the protrusions have a similar hardness to the body of said block for the purpose of improving the shear strength of said protrusions.

16. The mould in accordance with claim 14 include a depending portion adjacent the second mould portion for compelling the flowable concrete mixture thereinto.

17. The mould in accordance with claim 16 wherein the depending portion produces an indentation in the top of the masonry block.

18. The mould in accordance with claim 16 wherein the depending portion of the head shoe means the flowable concrete mixture that forms the protrusions is compressed to increase the hardness of the cured protrusions that results in increased sheer strength.
